(19) United States
(12) Patent Application Publication
(10) Pub. No.: US 2007/0276982 A1
(43) Pub. Date: Nov. 29, 2007

(54) THIRD SWITCH FOR VXS/VMEBUS COMPLIANT COMPUTING SYSTEM

(76) Inventor: Scott A. Denning, Colorado Springs, CO (US)

Correspondence Address: GREENBERG TRAURIG, LLP, 1200 SEVENTEENTH STREET, SUITE 2400, DENVER, CO, 80202, US

(21) Appl. No.: 11/420,396

(22) Filed: May 25, 2006

(51) Int. Cl. G06F 13/00

(52) U.S. Cl. 710/317

(57) ABSTRACT

Embodiments of the present invention take advantage of the extra slot and connectors in the P0/J0 position that are reserved for future use in the VXS standard to create a VXS-compliant backplane that has increased performance. The backplane is considered VXS-compliant in that it is compatible with VXS-compliant payload boards and switch boards. The backplane utilizes in the extra slot another VXS-compliant switch slot for a third VXS-compliant switch. The wiring of the switch slots are slightly modified to provide two differential pair serial connected between each of the three switch slots. Furthermore, wiring is added to the J0 connectors in at least one payload slot so that the payload slot is directly connected to each of the three switch slots. A payload board is also disclosed that is adapted to directly communicate with through the additional wiring with each of the three switches.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The VMEBus is a computer bus standard originally developed for the Motorola 68000 line of CPUs, but later widely used for many applications and standardized by the IEC as ANSI/IEE 1014-1987. In computer architecture, a bus is a subsystem that transfers data or power between computer components inside a computer or between computers. Unlike a point-to-point connection, a bus can logically connect several peripherals over the same set of wires. Each bus defines its set of connectors to physically plug devices, cards or cables together.

The VMEBus originally was a 16-bit bus, designed to fit within the existing Eurocard DIN connectors. However there have been several updates to the system to allow wide bus widths, and the current VME64 includes a full 64-bit bus in a 6U sized card, and 32-bit for 3U cards. The VME64 protocol has a typical performance of 40 MByte/s. Other associated standards have added hot swapping (plug-and-play) in VME64x, smaller cards known as IP's that plug into a single VMEbus card, and various interconnect standards for linking VME systems together.

One element of the VMEbus is a backplane into which VME-compliant payload boards can be inserted and removed. A backplane is a circuit board (usually a printed circuit board) that connects several connectors in parallel to each other, so that each pin of each connector is linked to the same relative pin (or some other specified pin) of all the other connectors, forming a computer bus. It is used as a backbone to connect several printed circuit board cards together to make up a complete computer system.

Recently, the VME system and the VMEBus has been refreshed with a new standard, the VMEBus Switched Serial Standard, VITA 41.0-2.00x (also referred to as the “VXS standard”). The VXS standard has under gone a number of revisions—the current revision being Revision 1.11, which is hereby incorporated herein by reference. The VXS base standard defines physical features that enable high-speed communication in a VME compatible system. These features include: addition of a high-speed connector to the VME64x board in the P0/J0 position, a 6U by 160 mm by 6HP Eurocard format board with many high-speed connectors which may act as a switch, and the backplane and chassis infrastructure needed to support these features.

A backplane that complies with the VXS standard (referred to herein as a “VXS backplane” or a “VXS-compliant backplane”) is a backplane into which a VXS-compliant payload board or switch board may be inserted. A VXS backplane may include a number of “payload slots” and “switch slots.” A payload slot is a position in the VXS backplane into which a payload board may be inserted. A payload board is a board, typically a printed circuit board containing one or more processors, memory and/or peripherals, that complies with the ANSI/VITA 1.1, VME64 Extensions standard and further complies to the VXS standard (notably the high-speed P0 connector, keying and alignment mechanisms).

A switch slot, as the name implies, is a position in the VXS backplane into which a switch board may be inserted. A switch board is a board that complies with the VXS switch board standard.

The original VMEBus was provided with 21 payload slots and no switch slots. While the VXS standard explicitly does not require a given number of payload slots or switch slots on a backplane, it includes a set of requirements for switch slots and payload slots on backplane, as well as requirements for switch boards and payload boards for those slots, backplane and boards to be VXS-compliant.

Even though the VXS standard did not require a specific configuration, it did describe an 18 payload slot/2 switch slot example that has become a common VXS-compliant backplane today. This two-switch “redundant star” backplane shown in the VXS standard in FIG. 1-2 and FIG. 5-1 in which 18 VXS-compliant payload slots and two VXS-compliant switch slots wired in a redundant star configuration.

Even though the standard states that “[a] 19” subrack can hold a backplane with a configuration of 18 payload slots and 2 switch slots” it actually can hold one more slot because of its backward compatibility with the VME standard. This extra slot has often been ignored by backplane manufacturers, and a typical VXS-compliant backplane will have only 20 slots. When the 21^{st} slot is used, it is usually a VME-compliant payload slot that is not VXS-compliant.

### SUMMARY OF THE INVENTION

Embodiments of the present invention take advantage of the extra slot and connectors in the P0/J0 position that are reserved for future use in the VXS standard to create a VXS-compliant backplane that has increased performance. The backplane is considered VXS-compliant in that it is compatible with VXS-compliant payload boards and switch boards. The backplane utilizes in the extra slot another VXS-compliant switch slot for a third VXS-compliant switch. The wiring of the switch slots are slightly modified to provide two differential pair serial connected between each of the three switch slots. Furthermore, wiring is added to the J0 connectors in at least one payload slot so that the payload slot is directly connected to each of the three switch slots. A payload board is also disclosed that is adapted to directly communicate with through the additional wiring with each of the three switches. Embodiments of the present invention have been tested and determined to operate with as much as a 50% increase in speed.

In one aspect, the present invention may be considered a computing device comprising a backplane having at least three VXS-compliant switch slots, a plurality of VXS-compliant payload slots, and a VXS-compliant high-speed connector connecting each of the plurality of VXS-compliant payload slots to each of the at least three VXS-compliant switch slots. The device also includes a switch board in each of the at least three VXS-compliant switch slots and at least one payload board adapted to communicate with each of the three switches through the VXS-compliant high-speed connector.

In another aspect, the present invention may be considered a backplane comprising only three VXS-compliant switch slots, a plurality of VXS-compliant payload slots. In the backplane, each of the plurality of VXS-compliant payload slots are connected to each of the three VXS-compliant switch slots by a VXS-compliant high-speed serial link.

In another aspect, the present invention may be considered a method for transmitting data from a first VXS-compliant payload board to a second VXS-compliant payload board. The method includes attempting to transmit data to a first switch for delivery to the second VXS-compliant payload board. The method also includes attempting to transmit data to a second switch for delivery to the second VXS-compliant payload board, upon determination that the first switch is busy. The method further includes attempting to transmit data to a third switch for delivery to the second VXS-compliant payload board upon determination that both the first and the second switch are busy.

In another aspect, the present invention may be considered a payload board compliant with a VXS standard. The payload board includes a processor, a P0 connector attached to the payload board and a first communication module connected to one or more Pins designated “RFU” by the VXS standard.

These and various other features as well as advantages which characterize the present invention will be apparent from a reading of the following detailed description and a review of the associated drawings. Additional features of the invention are set forth in the description which follows, and in part will be apparent from the description, or may be learned by practice of the invention. The benefits and features of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments of the present invention and are not meant to limit the scope of the invention in any manner, which scope shall be based on the claims appended hereto.

FIG. 1 illustrates an embodiment of a VXS-compliant backplane 100 provided with three switch slots 102, 104, 106 and 18 payload slots 108, all of which are VXS-compliant.

FIG. 2 illustrates an embodiment of interconnections between any of the payload slots 108 of FIG. 1 and the switch slots 102, 104, 106.

FIG. 3 illustrates an embodiment of a method for transmitting data from a first VXS-compliant payload board (the source) to a second VXS-compliant payload board (the target).

FIG. 4 illustrates a block diagram of components of an embodiment of a payload board adapted to utilize the three switch backplane.

### DETAILED DESCRIPTION

Embodiments of the present invention take advantage of the extra slot and connectors in the P0/J0 position that are reserved for future use in the VXS standard to create a VXS-compliant backplane that has increased performance. Embodiments of the present invention have been tested and determined to run at as much as a 50% increase in speed.

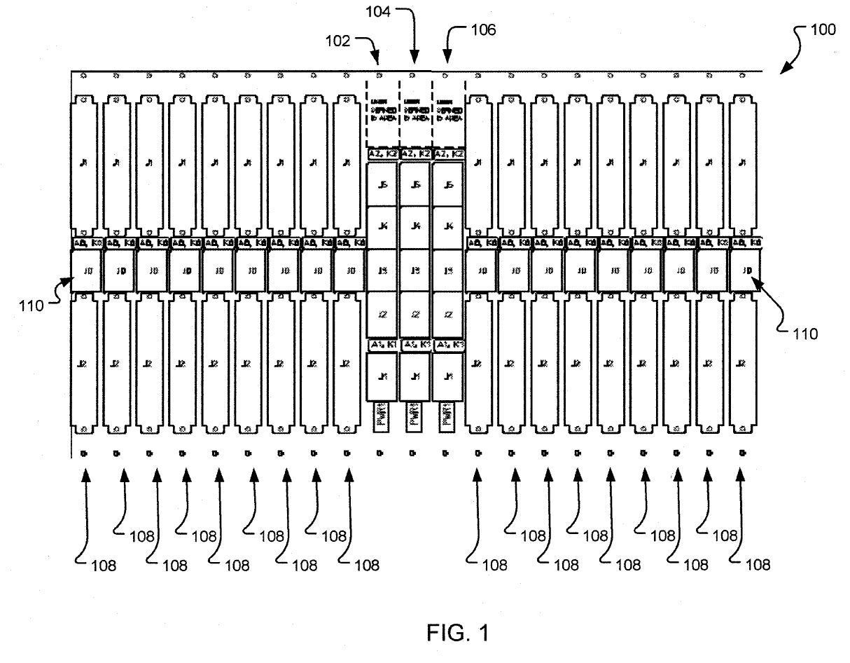

FIG. 1 illustrates an embodiment of a VXS-compliant backplane 100 provided with three switch slots 102, 104, 106 and 18 payload slots 108, all of which are VXS-compliant. Thus, the embodiment of FIG. 1 utilizes all 21 slots available in the VXS backplane. Alternative embodiments may include less VXS-compliant payload slots as desired.

For the purposes of this specification, a “VXS backplane” or a “VXS-compliant backplane” is a backplane into which a VXS-compliant payload board or switch board may be inserted and within which the VXS-compliant payload board or switch board will operate. Embodiments of the VXS-backplane described herein are referred to as VXS-compliant because the backplane is operable with VXS-compliant payload and switch boards, even though some of the pin connections between the slots differ from those listed in the VXS standard. For example, as described below some connections that are indicated in the VXS standard as “reserved for future use” and utilized in embodiments of VXS-compliant backplanes described herein. Thus, the embodiments of the VXS-compliant backplane described herein do not completely conform to the VXS standard but are still considered and referred to as VXS-compliant.

As mentioned above, the backplane 100 is VXS-compliant in that each of the switch slots are wired to the high-speed J0 connectors 110 on the payload slots 108 as required in the VXS standard. That is, some pins of the J2-J5 connectors in of the switch slots are wired to the J0 connectors 110 to comply with the standard.

In addition to complying with the VXS standard, one or more J0 connectors in the backplane 100 are wired to take advantage of the third switch slot. Under the VXS standard, a number of pins in the J0 connectors are listed as “RFU” which stands for “reserved for future use” as shown in Table 1. The VXS pin definitions for the J0 connector on the backplane and the corresponding P0 connector as described in the VXS standard are provided below:

TABLE 1
VXS Backplane J0 Connector Pin Definition

| | Row A | Row B | Row C | Row D | Row E | Row F | Row G | Row H | Row I |
|---|---|---|---|---|---|---|---|---|---|
| 1 | DP1+ | DP1− | GND | GND | DP2+ | DP2− | GND | GND | SE1 |
| 2 | GND | GND | DP3+ | DP3− | GND | GND | DP4+ | DP4− | GND |
| 3 | DP5+ | DP5− | GND | GND | DP6+ | DP6− | GND | GND | SE2 |
| 4 | GND | GND | DP7+ | DP7− | GND | GND | DP8+ | DP8− | GND |
| 5 | RFU | RFU | GND | GND | RFU | RFU | GND | GND | RFU |
| 6 | GND | GND | RFU | RFU | GND | GND | RFU | RFU | GND |
| 7 | RFU | RFU | GND | GND | RFU | RFU | GND | GND | RFU |
| 8 | GND | GND | RFU | RFU | GND | GND | RFU | RFU | GND |
| 9 | RFU | RFU | GND | GND | RFU | RFU | GND | GND | RFU |
| 10 | GND | GND | RFU | RFU | GND | GND | RFU | RFU | GND |
| 11 | RFU | RFU | GND | GND | RFU | RFU | GND | GND | PEN* |
| 12 | GND | GND | DP23+ | DP23− | GND | GND | DP24+ | DP24− | GND |
| 13 | DP25+ | DP25− | GND | GND | DP26+ | DP26− | GND | GND | SE7 |
| 14 | GND | GND | DP27+ | DP27− | GND | GND | DP28+ | DP28− | GND |
| 15 | DP29+ | DP29− | GND | GND | DP30+ | DP30− | GND | GND | SE8 |

TABLE 2
VXS Payload P0 Connector Pin Definition

| | Row G | Row F | Row E | Row D | Row C | Row B | Row A |
|---|---|---|---|---|---|---|---|
| 1 | SE1 | GND | DP2− | DP2+ | GND | DP1− | DP1+ |
| 2 | GND | DP4− | DP4+ | GND | DP3− | DP3+ | GND |
| 3 | SE2 | GND | DP6− | DP6+ | GND | DP5− | DP5+ |
| 4 | GND | DP8− | DP8+ | GND | DP7− | DP7+ | GND |
| 5 | RFU | GND | RFU | RFU | GND | RFU | RFU |
| 6 | GND | RFU | RFU | GND | RFU | RFU | GND |
| 7 | RFU | GND | RFU | RFU | GND | RFU | RFU |
| 8 | GND | RFU | RFU | GND | RFU | RFU | GND |
| 9 | RFU | GND | RFU | RFU | GND | RFU | RFU |
| 10 | GND | RFU | RFU | GND | RFU | RFU | GND |
| 11 | PEN* | GND | RFU | RFU | GND | RFU | RFU |
| 12 | GND | DP24− | DP24+ | GND | DP23− | DP23+ | GND |
| 13 | SE7 | GND | DP26− | DP26+ | GND | DP25− | DP25+ |
| 14 | GND | DP28− | DP28+ | GND | DP27− | DP27+ | GND |
| 15 | SE8 | GND | DP30− | DP30+ | GND | DP29− | DP29+ |

Notes:
1) DP+/− = differential pair, may be used single ended but are coupled in connector.
2) Example of differential pair; DP1+ on pin A1, DP1− on pin B1
3) Signal PEN* on pin G11 is power enable as defined in the VITA 41.10 Live Insertion standard.
4) SE = singled ended, these signals are not coupled to any others within the connector.
© Motorola, Inc. and VMEbus International Trade Association, 2002

Note that under the VXS standard the high-speed connectors used do not have a symmetric footprint on the payload board and the backplane. The J0 pin definition shown above in Table 1 corresponds to the P0 pin definition also shown above in Table 2. Signal mapping between the P0 and J0 is relative to the signal names, not the pin numbering.

Embodiments of the present invention are adapted so that some or all of the RFU pins of the J0 connector on the backplane are connected to connectors in the third switch slot. An example of an embodiment of J0 connector is provided below:

TABLE 3
An Embodiment of a Modified J0 Connector Pin Definitions For Third Switch

| | Row A | Row B | Row C | Row D | Row E | Row F | Row G | Row H | Row I |
|---|---|---|---|---|---|---|---|---|---|
| 1 | DP1+ | DP1− | GND | GND | DP2+ | DP2− | GND | GND | SE1 |
| 2 | GND | GND | DP3+ | DP3− | GND | GND | DP4+ | DP4− | GND |
| 3 | DP5+ | DP5− | GND | GND | DP6+ | DP6− | GND | GND | SE2 |
| 4 | GND | GND | DP7+ | DP7− | GND | GND | DP8+ | DP8− | GND |
| 5 | DP9+ | DP9− | GND | GND | DP10+ | DP10− | GND | GND | SE3 |
| 6 | GND | GND | DP11+ | DP11− | GND | GND | DP12+ | DP12− | GND |
| 7 | DP13+ | DP13− | GND | GND | DP14+ | DP14− | GND | GND | SE4 |
| 8 | GND | GND | DP15+ | DP15− | GND | GND | DP16+ | DP16− | GND |
| 9 | RFU | RFU | GND | GND | RFU | RFU | GND | GND | RFU |
| 10 | GND | GND | RFU | RFU | GND | GND | RFU | RFU | GND |
| 11 | RFU | RFU | GND | GND | RFU | RFU | GND | GND | PEN* |
| 12 | GND | GND | DP23+ | DP23− | GND | GND | DP24+ | DP24− | GND |
| 13 | DP25+ | DP25− | GND | GND | DP26+ | DP26− | GND | GND | SE7 |
| 14 | GND | GND | DP27+ | DP27− | GND | GND | DP28+ | DP28− | GND |
| 15 | DP29+ | DP29− | GND | GND | DP30+ | DP30− | GND | GND | SE8 |

In the embodiment shown above, pins definitions for pins A5, A7, B5, B7, C6, C8, D6, D8, E5, E7, F5, F7, G6, G8, H6 and H8 have been modified so that they are now connected to the third switch slot. This pin definition is still compliant with the VXS standard in that a VXS-compliant payload board will still operate as designed, as these payload boards will not be attempting to use the RFU pins. Alternative pin definitions are possible and within the scope of this disclosure. In the embodiment shown, each of the three switch slots are connected by the same number and type of connections to each J0 connector on the backplane.

Payload boards that have been modified to take advantage of the third switch now have three different switches, rather than two, for passing data to other boards connected to the backplane. Payload boards that have not been modified will function as before, but without direct access the third switch. The modification of a payload board to connect to the RFU pins and to detect and utilize the third switch is a simple process and well known in the art. Any suitable means is possible including adding additional Ethernet board, a MAC board or some other communication module connected to the P0 connector of the payload board. In an embodiment, a separate communication module may be provided for each switch. Thus, each communication module is attached to a different set of pins in the P0 connector. In an alternative embodiment, one communication module may be provided that is connected to each of the three switches through the P0 connector.

Payload boards may be designed to use any point-to-point interconnection standard, e.g., the Serial Gigabit Medium-Independent Interface (SGMII) or the X Attachment Unit Interface XAUI), for utilizing differential pair serial connections for communication with the switch boards via the J0 connectors. For example, a payload board may utilize the XAUI physical layer standard, originally intended for connecting 10 Gigabit Ethernet ports to each other and other electronic devices on a printed circuit board (see the IEEE 802.3 Standard Titled “Network Systems Tutorial for IEEE Std 802.3: Repeater Functions and System Design Topology Considerations for Carrier Sense Multiple Access with Collision Detection (CSMA/CD) Local Area Networks (LANs)” which is hereby incorporated by reference). Such a payload board may then utilize any XAUI-compliant communication protocol to communicate with a switch board including, for example, Ethernet including 10 Gigabit Ethernet, Fibre Channel, InfiniBand®, Serial RapidIO™, Xilinx's Aurora™, Dune Networks' Sand™, StarFabric® and PCI Express.

The corresponding pin definition for a modified P0 connector for use with a third switch is provided below.

TABLE 4
An Embodiment of a Modified P0 Connector Pin Definitions
For Third Switch

| | Row G | Row F | Row E | Row D | Row C | Row B | Row A |
|---|---|---|---|---|---|---|---|
| 1 | SE1 | GND | DP2− | DP2+ | GND | DP1− | DP1+ |
| 2 | GND | DP4− | DP4+ | GND | DP3− | DP3+ | GND |
| 3 | SE2 | GND | DP6− | DP6+ | GND | DP5− | DP5+ |
| 4 | GND | DP8− | DP8+ | GND | DP7− | DP7+ | GND |
| 5 | SE3 | GND | DP10− | DP10+ | GND | DP9− | DP9+ |
| 6 | GND | DP12− | DP12+ | GND | DP11− | DP11+ | GND |
| 7 | SE4 | GND | DP14− | DP14+ | GND | DP13− | DP13+ |
| 8 | GND | DP16− | DP16+ | GND | DP15− | DP15+ | GND |
| 9 | RFU | GND | RFU | RFU | GND | GND | RFU |
| 10 | GND | RFU | GND | GND | RFU | RFU | GND |
| 11 | PEN* | GND | RFU | RFU | GND | GND | PEN* |
| 12 | GND | GND | DP24− | DP24+ | GND | DP23− | DP23+ |
| 13 | SE7 | DP26− | DP26+ | GND | DP25− | DP25+ | GND |
| 14 | GND | GND | DP28− | DP28+ | GND | DP27− | DP27+ |
| 15 | SE8 | DP30− | DP30+ | GND | DP29− | DP29+ | GND |

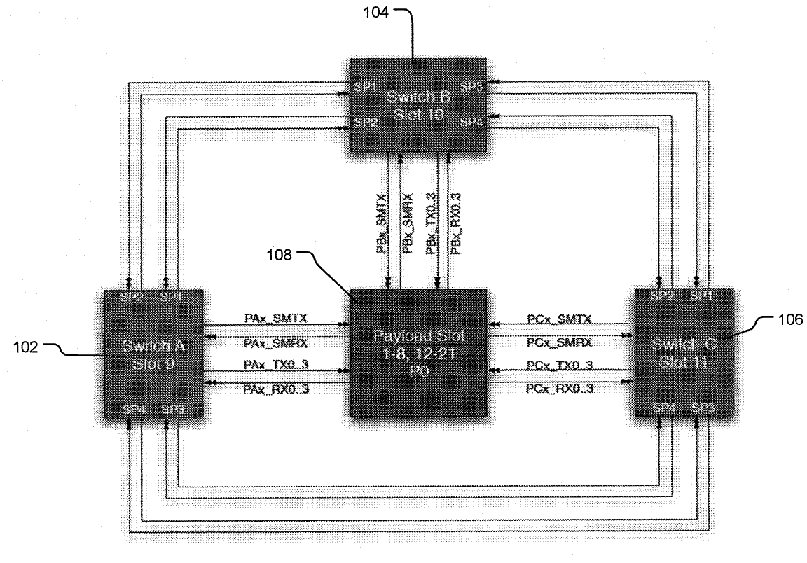

FIG. 2 illustrates an embodiment of interconnections between any of the payload slots 108 of FIG. 1 and the switch slots 102, 104, 106. In the embodiment shown, each of the payload slots 108 are connected to each of the switch slots 102, 104, 106 as described above. In addition, each of the switch slots are connected to each of the other switch slots, thereby creating a three-switch redundant star configuration.

The three-switch redundant star configuration allows each switch to pass communications directly to each other switch. Each switch, then, has three different routing paths to any given target payload board as shown in FIG. 2.

As mentioned above, pin definitions of embodiments of VXS-compliant backplanes discussed herein are slightly modified from those described the VXS standard. In addition to the wiring of the J0 connector discussed above, embodiments of VXS-compliant backplanes discussed herein differ in the way that the switches are interconnected. In the VXS standard, each of the two switches may be interconnected by four serial differential pair connections and pins are provided for such connections. In an embodiment, a VXS-compliant backplane includes three switch slots in which each switch slot is interconnected with the other two by two serial differential pair connections. This allows the same connectors and pins to be used, with the traces of the backplane only slightly rewired to change the interconnections between the three switch slots. Because the data transferred over these connections are addressed, the modified VXS-compliant backplane is still VXS-compliant and also still compatible with any VXS-compliant payload board or switch board.

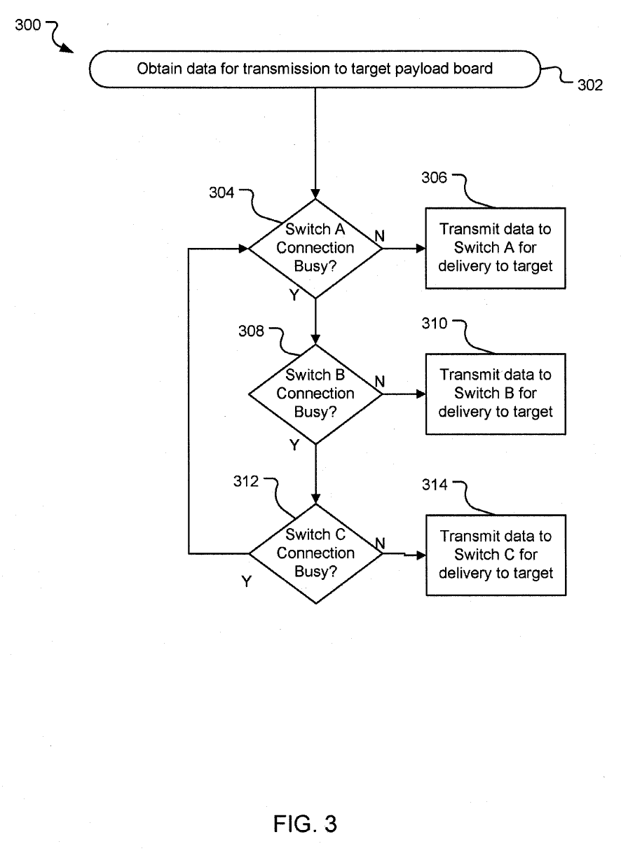

FIG. 3 illustrates an embodiment of a method for transmitting data from a first VXS-compliant payload board (the source) to a second VXS-compliant payload board (the target). In the method 300 shown, the source obtains data that must be transmitted via a backplane such as that described to the target in a obtain data operation 302.

Next, the source attempts to transmit the data to the target via a first one of the switches (herein arbitrarily referred to as “Switch A”). In an embodiment, the source may check to determine if the source's connection to the first switch (herein arbitrarily referred to as “Switch A”) is currently transmitting data in a check Switch A communication module operation 304. If the connection to Switch A is not in use, then the data is transmitted to the target via Switch A in a transmit data to Switch A operation 306.

If the Switch A connection is in use, the source then attempts to transmit the data via the second switch (“Switch B”). In an embodiment, the source checks to determine if the connection to the second switch is available in a check Switch B status operation 308. If the connection to Switch B is not in use, then the data is transmitted to the target via Switch B in a transmit data to Switch B operation 310.

If the Switch B connection is also in use, the source then checks to determine if the connection to the third switch (“Switch C”) is available in a check Switch C status operation 312. If the connection to Switch C is not in use, then the data is transmitted to the target via Switch C in a transmit data to Switch C operation 314.

If the source is currently transmitting data to each of the three switches, then the operations of the method may be repeated until a connection to a switch becomes available as shown. Alternatively, the system may queue the data for delivery in a buffer associated with a specified switch. Such a switch may be specified based on the relative amount of data in each of the switches queue and in order to balance the load on each of the switches placed on it by the source payload board.

The method 300 discussed above is but one embodiment of method for transmitting data over a three-switch redundant star configuration. Other embodiments are possible including simultaneous querying of each communication module's connection status with its associated switch upon receipt of the data.

In an alternative embodiment, a source payload board may also attempt to determine which switch is not currently transmitting data to the target. Thus, the payload board can identify the fastest connection path to the target by determining the status of each of the switches with respect to the target. For example, if connections with one or more switches are not busy (i.e., the switches are available), the source may then query the available switches to determine if any of the available switches are currently not transmitting data to the target.

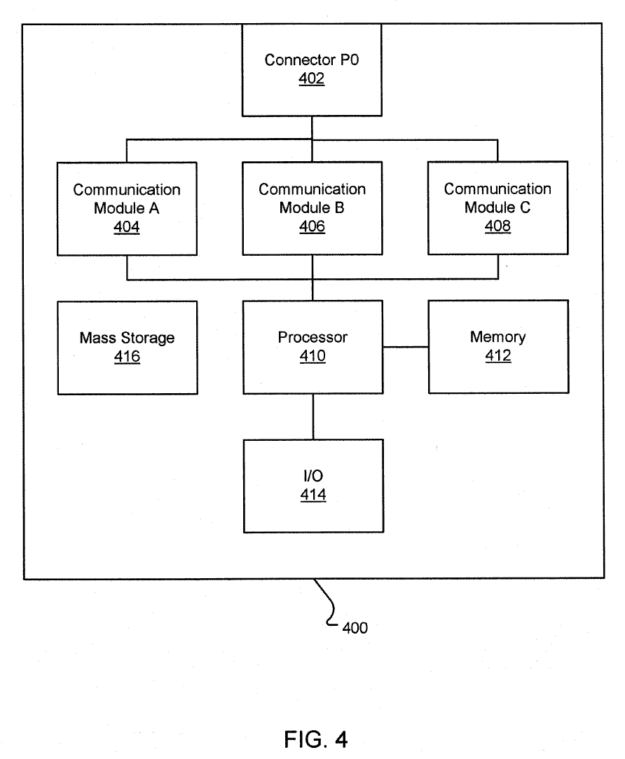

FIG. 4 illustrates a block diagram of components of an embodiment of a payload board adapted to utilize the three switch backplane. The payload board 400 includes the VXS-compliant P0 connector 402. In the embodiment shown, three communication modules 404, 406, 408 are connected to the P0 connector 402. Each communication module 404, 406, 408 is connected to a different set of pins in the connector 402 so that each module 404, 406, 408 is dedicated to handling communications between a specific switch (not shown) and the payload board 400.

The payload board 400 may also include some processor 410. The processor 410 may be a Motorola 68000 series processor as discussed above or may be any other processor by any manufacture such as Intel, Motorola, AMD. In addition, the processor 410 may include one or more processors, either on separate silicon chips or provided in one or more “multi-core” processing chips.

The payload board 400 may also include memory 412. The memory 412 may be separate and independent computer-readable media or may be included as part of any of the other modules described herein. The memory 412 may store data as well as computer-executable code for acting upon the data.

The payload board 400 may also include one or more mass data storage devices 416. The mass storage device 416 and its associated computer-readable media, provide non-volatile storage. Although the description of computer-readable media contained herein refers to a mass storage device, such as a hard disk or CD-ROM drive, it should be appreciated by those skilled in the art that computer-readable media can be any available media that can be accessed by the processor 410.

By way of example, and not limitation, computer-readable media may comprise computer storage media and communication media including memory 412 or mass storage 416. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

In an embodiment, the payload board 400 may include one or more data input/output modules 414.

Payload boards 400 may be adapted to any necessary purpose as desired by the selection of different software and hardware. Thus it may be possible to create payload boards for any particular function.

It will be clear that the present invention is well adapted to attain the ends and advantages mentioned as well as those inherent therein. Those skilled in the art will recognize that the methods and systems of the present invention within this specification may be implemented in many manners and as such is not to be limited by the foregoing exemplified embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope of the present invention. For example, the switch slots need not be located as shown in FIG. 1, but could be spaced apart or located at the ends of the backplane. Numerous other changes may be made which will readily suggest themselves to those skilled in the art and which are encompassed in the spirit of the invention disclosed and as defined in the appended claims.

1. A computing device comprising:
a backplane having at least three VXS-compliant switch slots, a plurality of VXS-compliant payload slots, and a VXS-compliant high-speed connector connecting each of the plurality of VXS-compliant payload slots to each of the at least three VXS-compliant switch slots;
a switch board in each of the at least three VXS-compliant switch slots; and
at least one payload board adapted to communicate with each of the three switch boards through the VXS-compliant high-speed connector.

2. The computing device of claim 1 wherein each switch board is adapted to communicate with each of the other two switch boards.

3. The computing device of claim 1 wherein the backplane is VXS-compliant.

4. The computing device of claim 1 wherein the backplane is VME-compliant.

5. The computing device of claim 1 wherein the backplane comprises three VXS-compliant switch slots and 18 VXS-compliant payload slots.

6. The computing device of claim 1 wherein each of the plurality of VXS-compliant payload slots is connected to each of the at least three VXS-compliant switch slots by four differential pair serial connections.

7. The computing device of claim 1 wherein each switch slot is connected to each of the other switch slots by four differential pair serial connections.

8. The computing device of claim 1 wherein at least one payload board communicates with at least one switch board via a serial communication protocol selected from 10 Gigabit Ethernet, Fibre Channel, InfiniBand®, Serial RapidIO™, Xilinx's Aurora™, Dune Networks' Sand™, StarFabric® and PCI Express.

9. A backplane comprising:
exactly three VXS-compliant switch slots;
a plurality of VXS-compliant payload slots; and
wherein each of the plurality of VXS-compliant payload slots are connected to each of the three VXS-compliant switch slots by a VXS-compliant high-speed serial link.

10. The backplane of claim 9 wherein each VXS-compliant payload slot includes a VXS-compliant J0 connector, each J0 connector electrically connected via the high-speed serial link to a connector in each of the three VXS-compliant switch slots.

11. The backplane of claim 9 wherein each of the three VXS-compliant switch slots is connected to the other two VXS-compliant switch slots.

12. The backplane of claim 9 further comprising:
a total of 18 VXS-compliant payload slots.

13. The backplane of claim 12 wherein the three VXS-compliant switch slots are located in a center three slots of the backplane.

14. The backplane of claim 9 wherein at least one payload board communicates with at least one switch board via a serial communication protocol selected from 10 Gigabit Ethernet, Fibre Channel, InfiniBand®, Serial RapidIO™, Xilinx's Aurora™, Dune Networks' Sand™, StarFabric® and PCI Express.

15. A method for transmitting data from a first VXS-compliant payload board to a second VXS-compliant payload board comprising:
attempting to transmit data to a first switch for delivery to the second VXS-compliant payload board;
upon determination that the first switch is busy, attempting to transmit data to a second switch for delivery to the second VXS-compliant payload board; and
upon determination that the second switch is busy, attempting to transmit data to a third switch for delivery to the second VXS-compliant payload board.

16. The method of claim 15 further comprising:
transmitting data to the third switch for delivery to the second VXS-compliant payload board.

17. A payload board compliant with a VXS standard comprising:
a processor attached to the payload board;
a P0 connector attached to the payload board; and
a first communication module connected to one or more pins designated “RFU” by the VXS standard.

18. The payload board of claim 17 wherein the first communication module is connected to pins A5, A7, B5-B8, C6, C8, D5, D7, E5-E8, F6 and F8 of the P0 connector.

19. The payload board of claim 17 further comprising:
a second communication module connected to pins F2, F4, E1-E4, D1, D3, C2, C4, B1-B4, A1 and A3 of the P0 connector; and
a third communication module connected to pins F13, F15, E12-E15, D12, D14, C13, C15, B12-15, A12 and A14 of the P0 connector.

20. The payload board of claim 19 wherein the first communication module, the second communication module, and the third communication module are combined into a single communication module.
